(19) United States
(12) Patent Application Publication
(10) Pub. No.: US 2014/0054229 A1
(43) Pub. Date: Feb. 27, 2014

(54) COMPOSITIONS AND PROCESSES FOR DEOILING AQUEOUS STREAMS WITH TALC

(71) Applicants: Marcelo Costa, (US); Lucas Moore, Atlanta, GA (US); Cynthia Cardoso, (US)

(72) Inventors: Marcelo Costa, (US); Lucas Moore, Atlanta, GA (US); Cynthia Cardoso, (US)

(21) Appl. No.: 13/590,801

(22) Filed: Aug. 21, 2012

(51) Int. Cl. B01D 17/05; C09K 3/00; E02B 15/04; C02F 1/52; C02F 1/58

(52) U.S. Cl. 210/705; 210/738; 210/708; 210/723; 516/138

(57) ABSTRACT

A deoiling or demulsifying composition including talc. Also disclosed is a process for removal of hydrocarbons, oil or oil-bearing formations from an aqueous stream by adding talc to the aqueous stream. The process may also include one or more of: aerating or injecting air or gas into the aqueous stream; agitating the treated stream to form a layer comprising the hydrocarbons, oil or oil-bearing formations; and separating the layer from the aqueous stream.

### FIELD OF THE ART

The present disclosure generally relates to compositions and processes for deoiling aqueous streams which contain hydrocarbons, oil or oil-bearing formations.

### BACKGROUND

In oil production, especially where high levels of water flooding or steam flooding are used, oil-in-water emulsions are generated. Deoiling, also called demulsifying, treatments may be used to reduce the amount of hydrocarbons or oil in the water so that the water may be recycled or returned to the environment. Other industries which produce waste waters containing oil-in-water emulsions include steel mill and metal working operations, food processing, refinery and chemical plant operations, cooling water blow-down, bitumen extraction from tar sands and shale oil operations, and rainwater run-off.

The oil or/and organic components with hydrophobic behavior in such waste waters is generally well dispersed in the water phase as very small droplets or micelles that are stabilized as a result of the presence of natural surfactants. The stability of these oil-in-water emulsions generally results from the either negative charge imparted by the droplets by these surfactants, or from steric stabilization caused by surfactants, or by shear which the fluid experiences during production, which causes the generation of smaller and more stable droplets, or from several other sources.

In oil exploration, produced water goes through a series of treatments prior to discharge. The lighter components of the oil or/and organic contaminants with hydrophobic behavior are skimmed off the top after a series of gravimetric techniques. The heavier oil components, which are generally between about 200-800 mg/L, are often treated by flotation techniques. Such techniques usually reduce the Total Oil and Grease (TOG) levels by about 50%. The use of chemical enhancers or deoilers are of interest in recent years as they can be applied as an additive to further enhance the effectiveness of the flotation, in particular to reduce the level of Total Oil and Grease to below about 20 mg/L.

### BRIEF SUMMARY

Disclosed herein are processes for removal of hydrocarbons, oil or oil-bearing formations from aqueous streams comprising: (a) adding about 1 to about 2000 mg/L of talc to the aqueous stream comprising hydrocarbons, oil or oil-bearing formations; (b) agitating the aqueous stream to form a layer comprising hydrocarbons, oil or oil-bearing formations on the aqueous stream; and (c) separating the layer comprising hydrocarbons, oil or oil-bearing formations from the aqueous stream. Processes further comprising the step of aerating, or injecting air or other gas into, an aqueous stream comprising hydrocarbons, oil or oil-bearing formations, are also provided, as well as deoiler compositions comprising talc and one or more types of flocculants.

The disclosure may be understood more readily by reference to the following detailed description of the various features of the disclosure and the examples included therein.

### DETAILED DESCRIPTION

The present disclosure is directed to processes for deoiling or demulsifying aqueous streams containing hydrocarbons, oil or oil-bearing formations with talc. It has been discovered that talc may be used to remove hydrocarbons, oil or oil-bearing formations from aqueous streams or water such that the treated aqueous streams or water may be reused or reintroduced into the environment. The present disclosure is also directed to deoiler compositions comprising talc and one or more types of flocculants, which may be used remove hydrocarbons, oil or oil-bearing formations from aqueous streams or water such that the treated aqueous streams or water may be reused or reintroduced into the environment. Generally, the processes may be used to provide deoiling without the use of formaldehyde. The processes may be used to provide deoiling without the use of carcinogenic or corrosive materials or reagents. The processes may be used to increase the oil recovery while minimizing the reactions with the hydrocarbons, oil, oil-bearing formations or other organic materials.

In exemplary embodiments, a process for removal of hydrocarbons, oil or oil-bearing formations from aqueous streams is provided, comprising: (a) adding about 1 to about 2000 mg/L of talc to the aqueous stream comprising hydrocarbons, oil or oil-bearing formations; (b) agitating the aqueous stream to form a layer comprising hydrocarbons, oil or oil-bearing formations on the aqueous stream; and (c) separating the layer comprising hydrocarbons, oil or oil-bearing formations from the aqueous stream.

As used herein, “talc” refers to a mineral composed of hydrated magnesium silicate. It occurs as foliated to fibrous masses and may be ground into a powder of desired particle size. In loose powder form, it is often referred to as talcum powder. It has a specific gravity of 2.5-2.8, a clear or dusty luster, and is translucent to opaque. Talc is not soluble in water, but under adequate shear generates a dispersion for regular application. Its color ranges from white to grey or green and it has a distinctly greasy feel.

In exemplary embodiments, talc may include hydrated magnesium silicate of any form, microstructure, mixture of microstructures, particle size or mixture of particle sizes. Talc can be used in the processes, for example, as a dry powder or as an aqueous dispersion. The form or particle size of the talc is not particularly limited, and any form suitable for use in the compositions and processes can be used. Talc is used in a wide range of industries including the manufacture of ceramics, paints, paper, and asphalt roofing. The end-uses for talc are determined by variables such as chemical and mineralogical composition, particle size and shape, specific gravity, hardness, and color.

As used herein, the terms “demulsifier” or “deoiler” are used in their ordinary sense as understood by one skilled in the art, and thus may be used to break or separate emulsions or to separate aqueous phases from hydrocarbon- or oil-containing phases in a mixture, for example to separate water from oil. A deoiler may also impact the flotation of hydrocarbon- or oil-containing phases and can be used as a flotation agent.

In exemplary embodiments, deoiler or demulsifier compositions may comprise talc and one more types of flocculants. In exemplary embodiments, the deoiler compositions may comprise talc as a powder or granulated form, or one or more types of talc diluted with an aqueous solvent and/or one or more other solvents. In an exemplary embodiment, the talc is a powder or granulated form with particle sizes in the range of about 3.5 to about 4.5 μm. In an exemplary embodiment, the talc is in an aqueous suspension. In another exemplary embodiment, the talc is a powder or granulated form with particle sizes in the range of about 3.5 to about 4.5 μm that is in an aqueous suspension.

In exemplary embodiments, the deoiler composition can be prepared by dissolving, or suspending, about 2 to about 10 wt. %, or about 2 to about 5 wt. %, of the talc in water, C₁ to C₁₆ alcohols, ethers, or other suitable solvents or mixtures of such solvents as required. In an exemplary embodiment, the deoiler composition comprises dissolving or suspending about 2 to about 5 wt. %, of the talc in water.

In exemplary embodiments, the one or more types of flocculants include, for example, flocculants with low or no anionic charge and medium to high viscosity. In exemplary embodiments, the one or more types of flocculants includes anionic or nonionic polyacrylamide flocculants. In exemplary embodiments, the one or more types of flocculants includes an anionic or nonionic polyacrylamide such as those marketed under the trade name Superfloc™ N300 or Superfloc™ 1849 RS (Kemira Chemicals, Inc.). In exemplary embodiments, the deoiler composition contains from about 1 to about 3 mg/L flocculant.

The deoiler compositions further comprise wetting improvement agents, surfactants, or other additives. Wetting improvement agents include but are not limited to oxyalkylated alcohols, phosphate esters, surface tension modifiers, acid and crude interface modifiers, such as arylalkylsulfonic acids or polyglycols. Other additives may include but are not limited to breaking speed improving and stabilizing agents such as polyglycols or alkylene oxide block copolymer blends. These include ethoxylated alcohols, alkylphenol/formaldehyde resins, oxyalkylated alkylphenol/formaldehyde resins, and their blends. Blends or mixtures of any of the aforementioned agents or additives as will be known to one of skill in the art may be used in the compositions and processes described herein.

In exemplary embodiments, the other additive may be hydrogen peroxide. The hydrogen peroxide can be added to the formulation, as necessary or desired, depending on the nature of the oil or hydrocarbon emulsion that is being broken. In exemplary embodiments, the talc, or the deoiler compositions comprising the talc and one or more types of flocculants, do not adversely react with hydrogen peroxide.

In exemplary embodiments, the deoiler compositions may be added in any necessary or desired amount to treat aqueous streams containing hydrocarbons, oil or oil-bearing formations. For example, in various embodiments, the deoiler composition may be added to an aqueous stream to provide from about 0.02 to about 4 wt. %, or about 0.05 to about 3 wt. % of the deoiler composition per 1000 gallons of an aqueous stream. In various exemplary embodiments, the deoiler composition may be added to an aqueous stream to provide from about 10 mg/L to about 600 mg/L, or about 10 mg/L to about 200 mg/L, of talc.

Generally, the talc, or the deoiler compositions comprising the talc and one or more types of flocculants, described herein may be used in various processes for removing hydrocarbons, oil or oil-bearing formations from aqueous streams and are not limited to the processes described in the following embodiments.

The expression “aqueous stream” as used herein refers to any aqueous liquid feed, in particular, an aqueous liquid feed that contain undesirable amounts of hydrocarbons, oil or oil-bearing formations. Exemplary aqueous streams include but are not limited to drinking water, ground water, well water, surface water, such as waters from lakes, ponds and wetlands, agricultural waters, wastewater, such as wastewater or leaching water from mining or industrial processes, and geothermal fluids. In certain embodiments, the processes can be used to remove hydrocarbons, oil or oil-bearing formations from any aqueous stream containing greater than about 20 mg/L hydrocarbons, oil or oil-bearing formations. In one embodiment, the process is effective for treating aqueous streams containing more than 200 mg/L hydrocarbons, oil or oil-bearing formations. In an exemplary embodiment, the process is effective in decreasing levels of hydrocarbons, oil or oil-bearing formations to below about 50 mg/L, about 40 mg/L, about 30 mg/L, about 20 mg/L, about 15 mg/L, about 10 mg/L, or about 5 mg/L.

In exemplary embodiments, the process for removal of hydrocarbons, oil or oil-bearing formations from aqueous streams comprises: (a) adding about 1 to about 2000 mg/L of talc to the aqueous stream comprising hydrocarbons, oil or oil-bearing formations; (b) agitating the aqueous stream to form a layer comprising hydrocarbons, oil or oil-bearing formations on the aqueous stream; and (c) separating the layer comprising hydrocarbons, oil or oil-bearing formations from the aqueous stream. In exemplary embodiments, the process for removal of hydrocarbons, oil or oil-bearing formations from aqueous samples comprises: (i) adding about 1 to about 600 mg/L of talc to the aqueous samples comprising hydrocarbons, oil or oil-bearing formations; (ii) agitating the aqueous samples; (iii) transferring the aqueous sample to an air-flotation cell; (iv) injection of bubbles from the bottom of the cell to form a layer comprising hydrocarbons, oil or oil-bearing formations on the aqueous sample; and (v) collecting the layer comprising hydrocarbons, oil or oil-bearing formations from the aqueous sample.

In exemplary embodiments, step (b) or step (ii) comprises agitating the aqueous stream for a suitable amount of time to form a layer of hydrocarbons, oil or oil-bearing formations that is distinct from the aqueous stream or water layer.

In exemplary embodiments, the separation in step (c) may be achieved by gravity settling, centrifuges, hydrocyclones, decantation, filtration, thickening, other gravimetric techniques, another mechanical separation method, or a combination thereof. In certain embodiments, the separation in step (c) further comprises skimming the layer comprising hydrocarbons, oil or oil-bearing formations from the aqueous stream. In other embodiments, the hydrocarbons, oil or oil-bearing formations may settle and some or all of the aqueous stream may be removed from on top of the layer comprising hydrocarbons, oil or oil-bearing formations.

In exemplary embodiments, one or more of the steps of the processes may be repeated more than once. In certain embodiment, the process comprises one or more separation steps. In certain embodiments, the process comprises one or more flotation steps, for example a step comprising aeration, or into air or another gas into, the aqueous stream.

In exemplary embodiments, an additive such as hydrogen peroxide may also be added before, with or after the addition of the talc to the aqueous stream. Exemplary additives may be provided in any amount, as necessary or desired. For example, in one embodiment, a hydrogen peroxide additive may be added to provide about 45 mg/L hydrogen peroxide to the aqueous stream.

In certain embodiments, the process is part of a dissolved air flotation process. In exemplary embodiments, the process for removal of hydrocarbons, oil or oil-bearing formations from aqueous streams comprises: (a) aerating, or injecting air or other gas into, an aqueous stream comprising hydrocarbons, oil or oil-bearing formations; (b) adding about 1 to about 2000 mg/L of talc to the aqueous stream comprising hydrocarbons, oil or oil-bearing formations before, during or after step (a); (c) agitating the aqueous stream to form a layer comprising hydrocarbons, oil or oil-bearing formations on the aqueous stream; and (d) separating the layer comprising hydrocarbons, oil or oil-bearing formations from the aqueous stream. In one embodiment, the aeration step is prior to the addition of the talc to the aqueous stream. In another embodiment, the aeration step is concurrent with the addition of the talc to the aqueous stream. In another embodiment, the aeration step is after the addition of the talc to the aqueous stream.

In exemplary embodiment, the process may further comprises a filtration step wherein the treated aqueous stream is passed through a filter, for example, a sand filter. In a particular embodiment, the filter is a sand filter with different granulometries.

In an exemplary embodiment, the process may further comprise a step wherein the aqueous stream to be treated is split, for example, one or more flocculants or deoiler compositions may be added to the aqueous stream and then the stream may be split such that part of the stream is treated with talc and part of the stream is sent to a different process.

The amount of talc required for sufficient removal of hydrocarbons, oil or oil-bearing formations from an aqueous stream in the processes described herein is dependent on the amount of oil or other organic compounds present in the aqueous stream and/or other factors. In one embodiment, the amount of talc added to the aqueous stream to be treated is less than the amount of natural solids oil content of the aqueous stream. In one embodiment, the talc can be used at a concentration of about 1 to about 2000 mg/L, about 5 to about 1000 mg/L, about 5 to about 500 mg/L, about 5 to about 150 mg/L, about 5 to about 100 mg/L, about 10 to about 200 mg/L, or about 15 mg/L to 150 mg/L to reduce the total oil and grease compounds in an aqueous stream to below about 50 mg/L, about 40 mg/L, about 30 mg/L, about 20 mg/L, about 15 mg/L, about 10 mg/L, or about 5 mg/L.

The rate of mixing or agitation after addition of the talc varies, depending on the type of aqueous stream being treated, the amount of hydrocarbons, oil or oil-bearing formations emulsified in the aqueous stream, temperature and several other conditions not generally under the control of the person applying the treatment. The layer containing hydrocarbons, oil or oil-bearing formations which has separated as a distinct layer from the aqueous stream or water after treatment with the talc can be separated from the aqueous stream or water by conventional methods. In exemplary embodiments, the removal of the oil fraction from the aqueous stream may be repeated or the oil fraction may be recovered in several steps.

In any of the processes described herein, the processes may further comprise the addition of flocculants, for example anionic flocculants. In an exemplary embodiment, one or more flocculants is added before the talc is added to the aqueous stream. In an exemplary embodiment, one or more flocculants is added simultaneously with the talc to the aqueous stream. In other exemplary embodiments, one or more flocculants is added after the talc is added to the aqueous stream.

In any of the processes described herein, the processes may further comprise the addition of other deoiler compositions which do not comprise talc, for example a polymer or formaldehyde-based deoiler. In an exemplary embodiment, one or more deoiler compositions is added before the talc is added to the aqueous stream. In an exemplary embodiment, one or more deoiler compositions is added simultaneously with the talc to the aqueous stream. In other exemplary embodiments, one or more deoiler compositions is added after the talc is added to the aqueous stream.

As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. A polymer may be a “homopolymer” comprising substantially identical recurring units formed by, e.g., polymerizing a particular monomer. A polymer may also be a “copolymer” comprising two or more different recurring units formed by, e.g., copolymerizing two or more different monomers, and/or by chemically modifying one or more recurring units of a precursor polymer. The term “terpolymer” may be used herein to refer to polymers containing three or more different recurring units.

The following examples are presented for illustrative purposes only, and are not intended to be limiting.

### EXAMPLES

### Example 1

### Dissolved Air Flotation Tests for Exemplary Deoiling Compositions

A dissolved air flotation (DAF) unit containing 6 individual cells and a pressurized tank was utilized in these experiments. The tank contained water pressurized to 80 lbs. with air. 800 mL of oily water was placed in each cell such that the level of the oily water was above the air jet inlet. The agitator was turned on and held constant. A known dosage (e.g. 1000 mg/L) of talc was added to each cell and allowed to stir for 5 minutes.

Upon filtering, the water treated with the talc deoiler was more clear than water treated with other commercially available deoiler formulations. In particular, the Total Oil and Grease (TOG) remaining in solution after treatment with the talc deoiler composition were 5-10 mg/L compared to 30 mg/L after treatment with the commercially available deoiler.

### Example 2

### Testing and Analysis of Exemplary Deoiling Compositions

In this example, exemplary deoiling compositions included the agents set forth in Table 1.

TABLE 1

| | | Anionic | | |
|---|---|---|---|---|
| | Talc | Polyacrylamide | Quaternary Ammonium | H₂O₂ |
| Sample | (mg/L) | Flocculant (mg/L) | Tannate (mg/L) | (mg/L) |
| 1 | 15 | 2 | — | — |
| 2 | 100 | 2 | — | — |
| 3 | 15 | 2 | — | 45 |
| 4 | — | — | 15 | — |
| 5 | — | — | 15 | 45 |
| 6 | — | — | 100 | 45 |

For each treatment sample, the talc or quaternary ammonium tannate was added to a beaker of 1 L of untreated produced water. (Note: the untreated produced water sample has some amount of inorganic solids.) The mixture was stirred mechanically for 20 minutes at 6000 rpm and then allowed to rest for 26.4 hours. The mixture was then stirred for an additional 20 minutes and, in certain samples, hydrogen peroxide was added at this point. The mixture was then subjected to an experimental flotation cell and, in certain samples, the anionic polyacrylamide flocculant was added to the mixtures containing talc. Air was bubbled into the mixtures for 10 minutes. 500 mL of the mixture was collected from the middle of the flotation cell and transferred to the separatory funnel. 50 mL of chloroform was added and each mixture was stirred and then allowed to rest (separate) for two minutes. The water phase (superior phase) was then separated from the oil and chloroform phase (inferior phase). The inferior phase was collected in a porcelain capsule and heated to 105° C. for 1 hour. The capsule, oil and solids from the sample were combined and weighed (weight=X mg), then placed on a 580° C. muffle furnace for 4 hours to burn off the oil. The remaining capsule and solids from the sample were weighed (weight=Y mg). The oil weight was determined as the difference between the X and Y weights.

Oil weight=(X−Y) mg

The oil concentration was determined as the difference between the X and Y weights, divided by 0.5 L.

Oil concentration (mg/L)=(X−Y) mg/0.5 L

The TOG, color, turbidity and oxygen level of the samples were assessed (see Table 2). For samples 1-6, the values reported are for each water sample after treatment with the deoiler composition.

TABLE 2

| | | | | Chemical Oxygen |
|---|---|---|---|---|
| | | | | Demand (mg/L |
| | TOG | Color | Turbidity | of O₂) (Data |
| Sample | (mg/L) | (Absorbance) | (NTU) | Quality Objective) |
| Control | 52 | 0.211 | 74.3 | 172 |
| (raw sample, | | | | |
| untreated) | | | | |
| 1 | 16 | 0.220 | 47 | 98 |
| 2 | 9 | 0.161 | 45.5 | 87 |
| 3 | 15 | 0.213 | 55.4 | 121 |
| 4 | 11 | 0.164 | 50 | 121 |
| 5 | 12 | 0.205 | 41.3 | 277 |
| 6 | 36 | 0.323 | 94.2 | 711 |

Notably, the Sample 2 (100 mg/L Talc and 2 mg/L Anionic Polyacrylamide Flocculant) reduced the TOG level of 9 mg/L. In contrast, Sample 6 (100 mg/L Quaternary Ammonium Tannate and 45 mg/L H₂O₂) reduced the TOG level to 36 mg/L. Sample 2 produced a Chemical Oxygen Demand of 87 mg/L of O₂ compared with a 711 mg/L of O₂ for Sample 6.

We claim:

1. A process for removal of hydrocarbons, oil or oil-bearing formations from aqueous streams comprising:
(a) adding about 1 to about 2000 mg/L of talc to the aqueous stream comprising hydrocarbons, oil or oil-bearing formations;
(b) agitating the aqueous stream to form a layer comprising hydrocarbons, oil or oil-bearing formations on the aqueous stream; and
(c) separating the layer comprising hydrocarbons, oil or oil-bearing formations from the aqueous stream.

2. The process of claim 1, wherein the process reduces the level of hydrocarbons, oil or oil-bearing formations in the aqueous stream to less than about 40 mg/L.

3. The process of claim 1, wherein the amount of talc added is about 10 to about 200 mg/L.

4. The process of claim 1, wherein step (b) comprises agitating the aqueous stream for a suitable amount of time to form a layer of hydrocarbons, oil or oil-bearing formations that is distinct from the aqueous stream or water layer.

5. The process of claim 1, wherein the separation in step (c) may be achieved by gravity settling, flotation, centrifuges, hydrocyclones, decantation, filtration, thickening, other gravimetric techniques, or another mechanical separation method.

6. The process of claim 1, wherein the separation in step (c) further comprises skimming the layer comprising hydrocarbons, oil or oil-bearing formations from the aqueous stream.

7. The process of claim 1, wherein the hydrocarbons, oil or oil-bearing formations may settle and some or all of the aqueous stream may be removed from on top of the layer comprising hydrocarbons, oil or oil-bearing formations.

8. The process of claim 1, wherein the talc is added as a dry powder.

9. The process of claim 1, wherein the talc is added as an aqueous suspension.

10. The process of claim 1, wherein the talc is added as a deoiler composition comprising the talc and one or more types of flocculants.

11. A process for removal of hydrocarbons, oil or oil-bearing formations from an aqueous stream comprising:
(a) aerating, or injecting air or other gas into, an aqueous stream comprising hydrocarbons, oil or oil-bearing formations;
(b) adding about 1 to about 2000 mg/L of talc to the aqueous stream comprising hydrocarbons, oil or oil-bearing formations before, during or after step (a);
(c) agitating the aqueous stream to form a layer comprising hydrocarbons, oil or oil-bearing formations on the aqueous stream; and
(d) separating the layer comprising hydrocarbons, oil or oil-bearing formations from the aqueous stream.

12. The process of claim 11, wherein step (a) is prior to step (b).

13. The process of claim 11, wherein step (a) is concurrent with step (b).

14. The process of claim 11, wherein step (a) is after step (b).

15. The process of claim 11, wherein the process reduces the level of hydrocarbons, oil or oil-bearing formations in the aqueous stream to less than about 40 mg/L.

16. The process of claim 11, wherein the amount of talc added is about 10 to about 200 mg/L.

17. The process of claim 11, wherein the talc is added as a dry powder.

18. The process of claim 11, wherein the talc is added as an aqueous suspension.

19. The process of claim 11, wherein the talc is added as a deoiler composition comprising the talc and one or more types of flocculants.

20. A deoiler composition comprising a talc and one or more types of flocculants.

21. The composition of claim 20, wherein the one or more types of flocculants are flocculants with low or no anionic charge and medium to high viscosity.

22. The composition of claim 20, wherein the composition further comprises hydrogen peroxide.

23. The composition of claim 20, wherein the composition further comprises water.
